(19) United States
(12) Patent Application Publication
(10) Pub. No.: US 2018/0036736 A1
(43) Pub. Date: Feb. 8, 2018

(54) PARABOLIC VIBRATION-PULSE MILL

(71) Applicant: TRANSMICRON LLC, Seattle, WA (US)

(72) Inventors: Vladimir Georgievich ANDRIENKO, Moscow (RU); Alexandr Revazovich MEREBASHVILY, Moscow (RU); Igor Nicolaevich JARTSEV, St. Petersburg (RU); Victor Leonidovich VASILEV, Gatchina (RU); Valery Anatolevich DONCHENKO, Moscow (RU); Valery Andreevich MOISEEV, Moscow (RU); Olga Alexandrovna PIROGOVA, St. Petersburg (RU)

(21) Appl. No.: 15/785,064

(22) Filed: Oct. 16, 2017

Related U.S. Application Data
(63) Continuation-in-part of application No. 14/405,004, filed on Dec. 2, 2014.

(51) Int. Cl. B02C 2/04; B02C 2/00

(52) U.S. Cl. CPC B02C 2/042; B02C 2/005; B02C 2210/02

(57) ABSTRACT

A parabolic vibration-pulse mill for grinding material, which comprises a case with an outer cone and an inner cone arranged inside on a spherical support, with driving vibrator mounted on a shaft of said inner cone through a bearing, the cones being fitted with mantles having working surfaces forming a grinding chamber between them, wherein, in a lower section of the grinding chamber, working surface of each mantle being formed by parabola of generatrix with its concavity, in longitudinal cross-section, facing a mill longitudinal axis; and wherein, in a upper section of the grinding chamber, working surface of each mantle being formed by parabola of generatrix with its convexity, in longitudinal cross-section, facing a mill longitudinal axis, and wherein conjugation of said parabolas is smooth.

Moreover, the mill, wherein parabolas can be defined by the formula h=k·r²/R, wherein “h” is the distance along an axis of the parabola, between a vertex of the parabola and circle formed by a cross section of the parabola, “r” is the radius of said circle, “R” is the radius of an sphere defined by the inner cone.

The mill with vertical distribution of material in the grinding chamber, providing a grinding ratio up to 30, with little wear of grinding mantles and low energy consumption.

### CROSS-REFERENCE TO RELATED APPLICATIONS

This application is a Continuation-in-Part of U.S. patent application Ser. No. 14/405,004, filed Feb. 12, 2014, which is a national stage entry of International Patent Application No. PCT/RU2012/000869, filed Oct. 25, 2012, all of which are incorporated herein by reference.

### BACKGROUND OF THE INVENTION

### 1. Field of the Invention

The present invention relates to machines for fine crushing and grinding of minerals and plant origin materials, and preferably the mill is for production of construction materials such as cement-a.

### 2. Description of the Prior Art

Production of cement and dry building mixtures is associated with high operation costs because the ball mills used for those purposes consume about 35 kWh per 1 ton of product with grain size finer than 0.071 mm. Furthermore, the wear of the grinding bodies' metal in that case is approximately 3 kg per 1 ton of product.

The expenses for crushing and grinding processes in the economical balance of a cement works represent 80% of all the costs. Therefore, to create mills that would allow energy and resource savings in this industry is a critical task for now.

In order to reduce energy costs, roller hydraulic presses are used prior to the mills, which bring about grinding of the clinker in the thick layer and reduce the total energy costs by 30%.

A new type of machine exists having high grinding ratios—about 15 on average. The grinding bodies of such machines are outer and inner cones, with an inner cone being driven by a vibrator.

U.S. Pat. No. 5,925,17 issued Jun. 3, 1986 discloses an inertia cone crusher which comprises a case with an outer cone and a spherical support of an inner cone having a shaft and a bearing-mounted vibrator pivoted to the spherical support. Such crusher's grinding ratio is not more than 10 because its vibrator is unable to develop high speed or substantial crushing force sufficient to obtain powders. This is explained by the fact that oil is fed into the vibrator's bearing from outside into the gap between the bearing bush and the cone's shaft, so that the outward centrifugal force hinders the oil from coming inside the gap. For this reason a crusher of that kind, in case of insufficient oil coming into the vibrator's bearing, may only operate for the production of stone chippings and is not able to act as a mill.

U.S. Pat. No. 4,655,405, dated Apr. 7, 1987 discloses an inertia cone crusher which comprises a case having an outer cone and an inner cone mounted on a spherical support and a shaft with a bearing-mounted driving vibrator which, in its turn, is driven by a counter-vibrator. The inner cone mantle profile is an approximated sphere while the outer cone mantle profile has a conical surface. The top part of said inner cone slows down the material feed, thus improving the grinding ratio. However, the incoming lump size in this case decreases by 30%, resulting in the same grinding ratio of the previous countertype equal to 10. This does not allow utilizing the said machine as a mill.

The above cited crushers provide intra-layer grinding of pieces of material by each other, however, the material inside the layer is crushed predominantly due to compression strain rather than due to shear strain. This is attributable to the geometry of the grinding chamber profiles, thus disallowing utilizing such machines as mills.

RF Patent No. 2383390, dated Aug. 26, 2008, discloses a prototypic parabolic vibration pulse mill that comprises a case with outer cone and inner cone arranged on a spherical support with a shaft on which a drive vibrator is mounted with a bearing, generating lines of cone mantles in a lower part of the grinding chamber being parabolas while generating lines in a top part that are straight.

Such design provided high grinding ratio—up to 20 due to shear strains of material layer not only in the horizontal plane but also in the vertical plane. However such complicated traveling motion of working surfaces resulted in almost doubled wear of mantles as compared to countertypes. Furthermore, material enters the grinding chamber without slowing down and is repressed, thus to maintain said grinding ratio it would require greater forces and, consequently, greater energy. Those drawbacks bring the obtainable advantages to a minimum.

It would be therefore convenient to have a new mill for fine crushing and grinding materials with crushing degree up to 30, with high life term of the mantles and the machine in whole.

### SUMMARY OF THE INVENTION

It is therefore an objective of the present invention to provide a new vibration pulse grinding mill that provides a grinding ratio up to 30 and is capable of replacing a ball mill in closed cycle operations.

The said objective is achieved in a parabolic vibration-pulse mill, comprising:

a case with an outer cone and an inner cone arranged inside on a spherical support, with driving vibrator mounted on a shaft of said inner cone through a bearing, the cones being fitted with mantles having working surfaces forming a grinding chamber between them,

wherein, in a lower section of the grinding chamber, working surface of each mantle being formed by parabola of generatrix with its concavity, in longitudinal cross-section, facing a mill longitudinal axis;

and wherein, in accordance with this invention, in a upper section of the grinding chamber, working surface of each mantle being formed by parabola of generatrix with its convexity, in longitudinal cross-section, facing a mill longitudinal axis, and wherein conjugation of said parabolas is smooth.

According to the invention, the parabolas of generatrices can be defined by the formula h=k·r²/R, wherein “h” is the distance along an axis of the parabola, between a vertex of the parabola and circle formed by a cross section of the parabola, “r” is the radius of said circle, “R” is the radius of an sphere defined by the inner cone, wherein coefficient k=3.6 for a parabola of generatrix in the upper section of the inner mantle, k=6.4 for a parabola of generatrix in the upper section of the outer mantle, and k=1.4 for parabolas of generatrices in the lower section of the inner mantle and in the lower section of the outer mantle.

The particular design of the grinding chamber of the invention provides conditions not only for compression of material layer in the charging zone of the grinding chamber but also for its shearing both in radial as well as tangential directions. Such effect ensures a higher grinding ratio in the upper charging zone as compared to the prototype.

Intermediate zone from the upper charging zone to the lower discharge zone of the grinding chamber provides possibilities to slow down the material flow, being accumulative zone with function of dosing of feeding for the lower discharge zone, so the discharge zone is not repressed by the material, and the inner cone retains greater amplitude and crushing force with low wear of mantles.

Therefore, an increase in grinding ratio up to 30 with low wear of mantles and lower energy consumption is ensured by means of the presented distinctive features.

### BRIEF DESCRIPTION OF THE DRAWINGS

The present invention is illustrated by way of example in the following drawings wherein:

FIG. 1 shows a longitudinal cross-section of the mill of the invention;

FIG. 2 is a longitudinal amplified cross-sectional view the grinding chamber according to the invention;

FIG. 3 is a longitudinal amplified semi-cross-sectional view the grinding chamber according to the invention, illustrating the disintegration process of the material under grinding, and

FIG. 4 shows the settlement scheme for creation of an initial profile of the inner mantle for the lower section of the grinding chamber.

### DESCRIPTION OF THE PREFERRED EMBODIMENTS

Now referring in detail to the invention, the same comprises a vibration pulse mill, preferably for grinding of building mixes, wherein the mill comprises foundation 1 with resilient shock absorbers 2 supporting case 3 with outer cone 4 accommodating spherical support 5 and inner cone 6 with shaft 7 on which cylindrical bearing 8 is installed holding vibrator 9, namely unbalanced weigh. Cones 4 and 6 are fitted with mantles 10 and 11, respectively, which are wear-resistance shells. Said vibrator 9 is connected to motor 12 by means of cylindrical bearing 8, compensating shaft 13 and V-belt drive 14. The volume between working surfaces of mantles 10 and 11 is grinding chamber 21. Above the grinding chamber 21 feeding hopper 22 is arranged. Lower portions of mantles 10 and 11 are shaped by parabolic generatrices 16 and 17 with their concavities facing the mill longitudinal axis H, forming discharge zone 15. Upper portions of mantles 10 and 11 are shaped by parabolic generatrices 18 and 19 with their convexities facing the mill longitudinal axis H, forming charging zone 20. The ends of said parabolas of each mantle are smoothly conjugated.

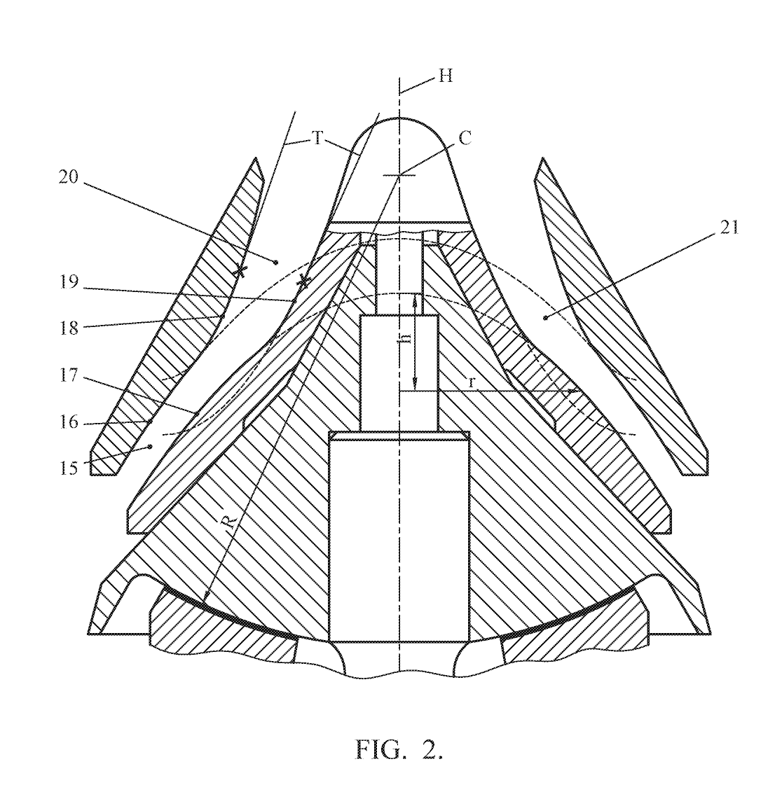

According to the invention, the parabolas of generatrices forming the mantles 10, 11 can be described by the following formula, see FIG. 2:

h=k·r²/R, (1)

where

h—distance along an axis of the parabola, between a vertex of the parabola and circle formed by a cross section of the parabola;

k—coefficient;

r—radius of said circle, which is the cross section of the parabola;

R—radius of an sphere defined by the inner cone.

By inserting coefficient k in formula (1), the formula is as follows:
for inner mantle 11:

h=3.6·r²/R−upper parabola,

h=1.4·r²/R−lower parabola;
for outer mantle 10:

h=6.4·r²/R−upper parabola,

h=1.4·r²/R−lower parabola.

In other words, coefficient k=3.6 is for a parabola of generatrix in the upper section of the inner mantle, k=6.4 is for a parabola of generatrix in the upper section of the outer mantle, and k=1.4 is for a parabola of generatrix in the lower section of the inner mantle and in the lower section of the outer mantle.

Such a design of the grinding chamber 21 is the result, as it will be explained below, of mathematical analysis of vibration movement and disintegration of a layer of material in the grinding chamber during operation, and also of its technological check.

In particular, the profile of the working surface of the inner cone is constructed taking into account frequency of oscillations of inner cone with average amplitude of points of its mantle, average fineness of particles, tilt angle of the estimated generating line and the capture angle, which should not exceed 18°, in each cross-section of the layer, at that the two last parameters form a basis for creation of a reciprocal profile of the working surface of outer mantle.

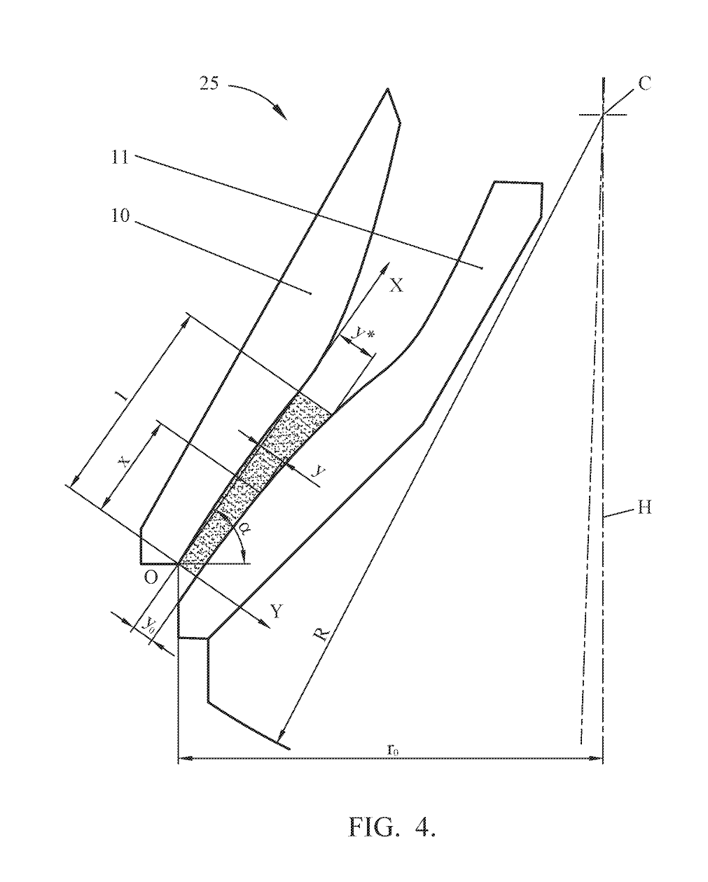

The settlement scheme for creation of initial profile of the inner mantle for the lower section of the grinding chamber on the side of maximum closeness of the inner cone to the outer cone is represented in FIG. 4.

A rectangular system of coordinates “XOY” is employed in the settlement scheme in FIG. 4, with the origin on the lower edge of the outer mantle of the fragment of the grinding chamber on the circle with radius “r₀” turned so that the axis “OX” is inclined on angle “α” as to the horizontal line.

The geometry of an initial profile of the inner mantle for the lower fragment of the grinding chamber is set by the following equation:

$$η = {[ ( 1 - {i}^{1 - {n}^{*}} ) \frac{ b ( 1 - b cos α )}{ c ( 1 - c cos α )} + {i}^{1 - {n}^{*}} ]}^{\frac{1}{{n}^{*} - 1}} , \qquad ( 2 )$$

where

η=y/y*—relative transverse coordinate of a point of the generatrix of the inner mantle;

y—transverse coordinate of a point of the generatrix of the inner mantle;

y*—value of the coordinate “y” in the reception section of the fragment of the grinding chamber;

i=y*/y₀—ratio of the coordinates “y” in the reception and discharge sections of the fragment of the grinding chamber;

y₀—value of the coordinate “y” in the discharge section of the fragment of the grinding chamber;

b=x/2r₀—relative longitudinal coordinate of a point of the generatrix of the inner mantle;

r₀—radius of the lower edge of the fragment of the grinding chamber;

c=l/2r₀—ratio of the estimated length of the generatrix to diameter of the lower edge of the fragment of the grinding chamber;

n*—an exponent in Gaudin-Andreyev's equation for the granulometric distribution of material in the fragment of the grinding chamber:

q=(d/dₘₐₓ)^{n*}, (3)

where

q—the relative content of the class passing through a sieve with size opening “d”;

dₘₐₓ—the smallest size of a sieve opening through which 100% of material passing.

The operational principle of the mill of the invention is described below. From motor 12 via V-belt drive 14 and compensating shaft 13, torque is transmitted to vibrator 9, which is an unbalanced weigh, which rotates through cylindrical bearing 8 on shaft 7 and creates centrifugal force inducing inner cone 6 to make circular oscillations about center “C” of spherical support 5 of inner cone 6.

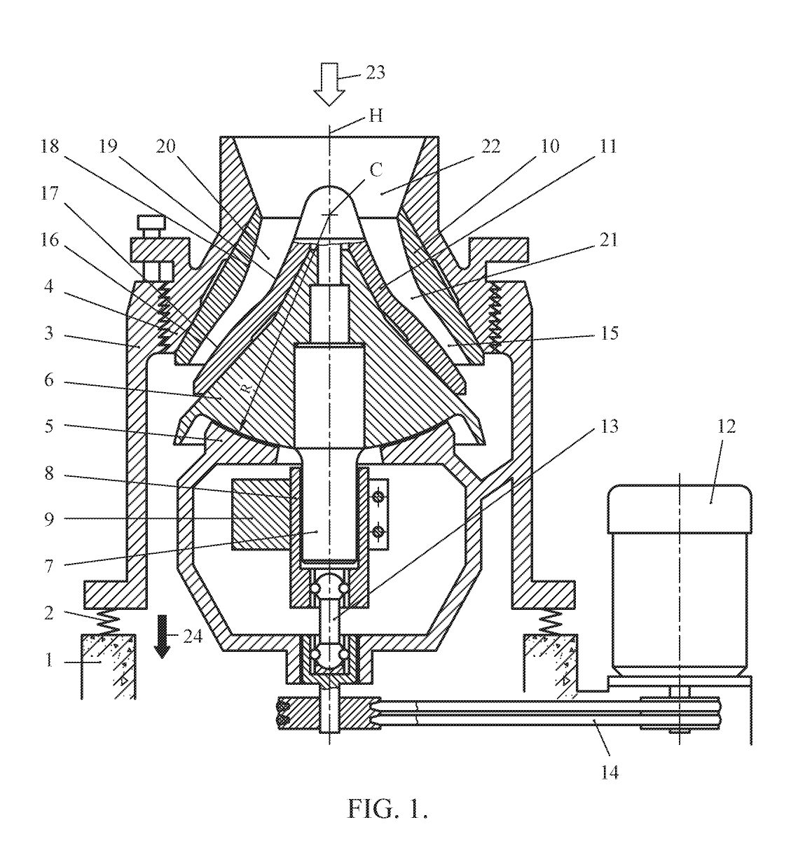

In FIG. 1, the direction the material is fed to the feeding hopper 22 of the mill is indicated by arrow 23, and the direction of discharging of ground product is indicated by arrow 24.

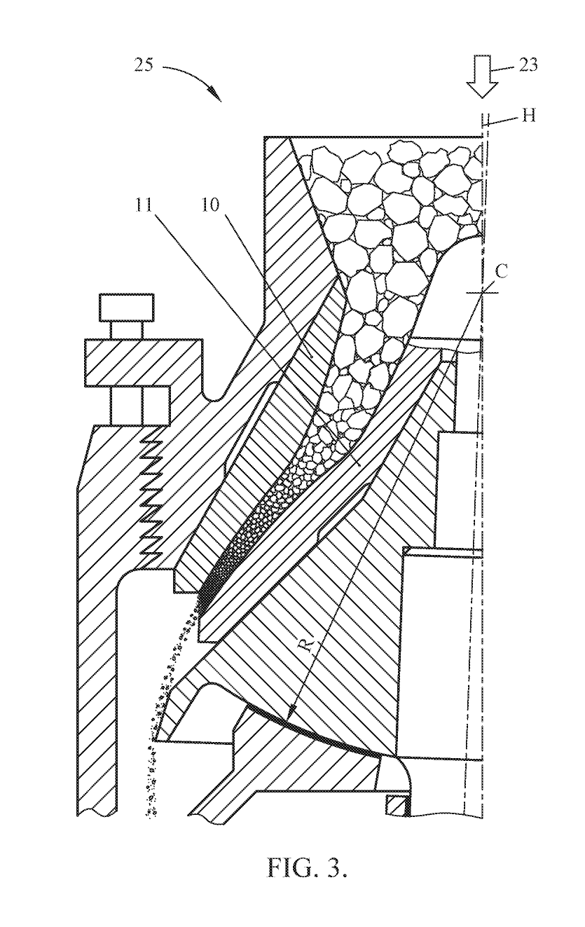

Material is fed by gravity from the feeding hopper 22 to the grinding chamber 21 and it is crushed inside its own layer piece by piece through compression by the approaching movement of mantles 10 and 11 of cones 4 and 6. When material comes into the charging zone 20 of the chamber 21 between parabolic generatrices 18 and 19, it undergoes not only compression but also shear both in radial as well as in tangential directions since the tangent lines “T” in the midpoint of the top parabolic generatrices 18 and 19 do not cross sphere center “C”, which leads to shearing strains in the material layer and assures the effect of grinding big lumps, thus increasing here the grinding ratio. Certain slowdown of inner cone 6 due to said shearing strain also results in forward slip of vibrator 9 relative the plane 25, depicted in FIG. 3 and in FIG. 4, which can be created as result of longitudinal cross-section of chamber 21 at the moment of maximal approaching of mantles 10, 11. When resistance is reset, the vibrator 9 approaches to said plane, and crushing force grows at the same time. Such force pulses occur approximately 60 times per revolution of the inner cone, resulting in intermittent layer strains and further increasing the disintegrating effect. Therefore, with the rotation speed of said vibrator 1000 revolutions per minute, which corresponds to the number of oscillations of said inner cone, there will be 60 thousand pulses acting on the layer or 1000 pulses per second.

When material falls in intermediate zone from the upper charging zone 20 to the lower discharge zone 15 of the grinding chamber 21, it is slowed down, providing loosening of the layer in the lower zone 15, where lower parabolic generatrices 16 and 17 face by their convexities to the opposite side now.

Due to that the amplitude of said inner cone increases along with the crushing force. Therefore, also in the discharge zone 15 the grinding ratio remains high with low wear of the mantles.

Such active vibration pulse grinding effect of the layer, with the novel grinding chamber, allows obtaining more than 50% of finished grain size cement upon clinker crushing, which is close in performance to the ball mill yield. With that, however, energy consumption will be reduced by 10 times, while the wear of the grinding bodies will be 50 times lower.

The applicants carried out comparative technological tests of the inventive vibration pulse mill at their factory with the traditional mantles, corresponding to machines above mentioned as analogs and prototype, as well as with new developed parabolic mantles in accordance with the present application.

Experimental tests of the claimed vibration pulse mill with 700 mm diameter of bottom of the inner cone with crushing of quartzites with Bond index Wi=20 with 40 t/h capacity showed exit in product of 35% of class less than 100 microns at reduction ratio 26. And with crushing of clinker the product was obtained with containing 49% of the same class at reduction ratio 35.

Therefore, the distinctive features of this invention assure achievement of the said objective.

### INDUSTRIAL APPLICABILITY

This invention can be most widely used for production of construction materials such as cement.

We claim:

1. Parabolic vibration-pulse mill, comprising:
a case with an outer cone and an inner cone arranged inside on a spherical support, with driving vibrator mounted on a shaft of said inner cone through a bearing, the cones being fitted with mantles having working surfaces forming a grinding chamber between them,
wherein, in a lower section of the grinding chamber, working surface of each mantle being formed by parabola of generatrix with its concavity, in longitudinal cross-section, facing a mill longitudinal axis;
and wherein, in a upper section of the grinding chamber, working surface of each mantle being formed by parabola of generatrix with its convexity, in longitudinal cross-section, facing a mill longitudinal axis, and wherein conjugation of said parabolas is smooth.

2. The mill of claim 1, wherein parabolas are defined by the formula h=k·r²/R, wherein “h” is the distance along an axis of the parabola, between a vertex of the parabola and circle formed by a cross section of the parabola, “r” is the radius of said circle, “R” is the radius of an sphere defined by the inner cone, wherein coefficient k=3.6 for a parabola of generatrix in the upper section of the inner mantle, k=6.4 for a parabola of generatrix in the upper section of the outer mantle, and k=1.4 for parabolas of generatrices in the lower section of the inner mantle and in the lower section of the outer mantle.
